(19) United States
(12) Patent Application Publication
(10) Pub. No.: US 2022/0358597 A1
(43) Pub. Date: Nov. 10, 2022

(54) SPECIALIZED INSURANCE FOR FOOTWEAR

(71) Applicant: SoleSafe LLC, St.Paul, MN (US)

(72) Inventor: Phillip Richard Tyrone Terrill, South St. Paul, MN (US)

(21) Appl. No.: 17/734,251

(22) Filed: May 2, 2022

Related U.S. Application Data
(60) Provisional application No. 63/183,943, filed on May 4, 2021.

(51) Int. Cl. G06Q 40/08; G06Q 30/06; G06Q 30/02

(52) U.S. Cl. CPC G06Q 40/08; G06Q 30/0611; G06Q 30/0278

(57) ABSTRACT

An automated shoe insurance quote system, including a user interface presentable on a display of one or more mobile computing devices in electrical communication with one or more servers, the user interface configured to enable a user to specify details regarding a pair of sneakers to be insured, display an estimated value of the pair of sneakers, wherein the estimated value of the pair of sneakers is determined by obtaining sales data from one or more online retail venues, and present one or more insurance coverage plans for selection by the user, wherein a coverage value of the one or more insurance coverage plans is determined by the current estimated value of the pair of sneakers.

### RELATED APPLICATION INFORMATION

This application claims the benefit of U.S. Provisional Application No. 63/183,943, filed May 5, 2021, the contents of which are fully incorporated herein by reference.

### TECHNICAL FIELD

The present disclosure relates generally to the field of insurance and more particularly- to a specific approach and method of calculating insurance premiums for sneakers and other types of footwear.

### BACKGROUND

The insurance industry was created to eliminate risk, especially regarding cargo, property, death, automobile accidents, and medical treatment. Insurance companies provide a wide range of insurance products to protect an even wider range of valuable assets, for example, including watches, furs, jewelry, handbags, trading cards, etc., often with specialized products or insurance companies tailored to insure specific products.

The emergence of technology has prompted new ideas to protect consumers. Specifically, as consumer needs and desires are changing, insurance products continue to evolve through modern processes and technologies. One emerging area of rapid growth in the insurance industry is the new asset class of high-end footwear (alternatively referred to herein as “sneakers”). The global sneaker market is positioned to exceed $120B by 2026. As of today, the sneaker resale market in the United States is valued at $2B and growing at 20% each year.

Sneakers represent assets that can be liquidated at any point, with the variable value based on condition, style, size, etc. In many cases, sneakers can be resold for multiples far above the original release prices. Accordingly, at the point of purchase or beyond, many consumers can have a desire to insure these assets; however, traditional methods of protecting these assets are currently quite limited.

Typically, the owner must either provide explicit transaction details, receipts, or other proofs of purchase (e.g., photos, etc.) to achieve maximum valuation. Additionally, it is a challenge to receive an appraisal value for sneakers, given multiple sources or sales venues, influence of hype, proof of authenticity, potential depreciation based on a shoe “in-transit” or being worn, and much more that impacts the actual market valuation of a sneaker. The present disclosure addresses these concerns.

### SUMMARY OF THE DISCLOSURE

Embodiments of the present disclosure provide a specific approach and method of calculating insurance premiums, specifically for sneakers. The disclosed sneaker insurance products and methods are based on intelligently calculated premiums for each sneaker based on a derived market value sourced from multiple sneaker resale sites/platforms. The present disclosure makes it possible for a sneaker consumer to accurately validate sneaker market value, receive instant appraisal via quote, and specifically insure sneakers to protect their investment.

The specific approaches and methods as discussed herein can be used to insure any sneaker of value by assessing risk and probability of peril/damages/loss. In some embodiments, a user can begin by searching for a sneaker by inputting a shoe name, shoe size, and zip code. This information can be used to source that specific model (or similar models), calculate/derive market value from available sneaker resale platforms, further calculate a quote based on potential perils requiring (cleaning, restoration, or replacement), and producing a quote back to the user. This quote can then be used as the baseline value as the customer adds/removes coverage options. Based on customer/user coverage selections, the premium price can be adjusted to reflect those inputs. Once a desired coverage is selected, the customer can be presented a summary/payment screen to complete coverage.

One embodiment of the present disclosure provides an automated insurance quote system, including a user interface presentable on a display of one or more mobile computing devices in electrical communication with one or more servers, the user interface configured to: enable a user to specify details regarding a pair of sneakers to be insured, display an estimated value of the pair of sneakers, wherein the estimated value of the pair of sneakers is determined by obtaining sales data from one or more online retail venues, and present one or more insurance coverage plans for selection by the user, wherein a coverage value of the one or more insurance coverage plans is determined by the current estimated value of the pair of sneakers.

In one embodiment, specifying details regarding the sneakers includes at least one of identifying a brand, model, gender, size, color or condition of the pair of sneakers. In one embodiment, the user interface is further configured to display at least one of a stock photograph or general information regarding the pair sneakers to enable a user to confirm proper identification of the pair of sneakers. In one embodiment, the user interface is further configured to enable the user to specify an intended usage of the pair of sneakers. In one embodiment, the user interface is further configured to enable user to select one or more online retail venues for use in determining the estimated value of the pair sneakers.

In one embodiment, the system further includes a local database configured to store price data obtained from the one or more online retail venues. In one embodiment, the system is configured to autonomously adjust the coverage value of the one or more insurance coverage plans on a periodic basis, based on an updated estimated value of the pair of sneakers. In one embodiment, the user interface is further configured to display an estimated value of the pair of sneakers over a finite period of time. In one embodiment, the system is configured to identify trends in an estimated value of the pair of sneakers over a finite period of time. In one embodiment, the system is configured factor the number of similar pairs of sneakers currently for sale on the one or more online retail venues in a determination of a current estimated value of the pair of sneakers. In one embodiment, the system is configured to employ a neural network algorithm in the determination of the estimated value pair of sneakers.

In one embodiment, the user interface is further configured to present a virtual collection of pairs of sneakers and the estimated current value associated with each pair of sneakers in the virtual collection. In one embodiment, the user interface is further configured to present a certificate of appraisal for the pair of sneakers.

Another embodiment of the present disclosure provides an automated insurance quote system, including a server configured to communicate with one or more mobile computing devices, the server configured to receive details regarding a pair of sneakers to be insured, obtain sales data for the pair of sneakers from one or more online retail venues to determine a value of the pair of sneakers, and enable the selection of one or more insurance coverage plans for the pair of sneakers, wherein a coverage value of the one or more insurance coverage plans is determined by the current estimated value of the pair of sneakers.

In one embodiment, the server is further configured to autonomously adjust the coverage value of the one or more insurance coverage plans on a periodic basis, based on an updated estimated value of the pair of sneakers. In one embodiment, the server is further configured factor the number of similar pairs of sneakers currently for sale on the one or more online retail venues in a determination of a current estimated value of the pair of sneakers. In one embodiment, the server is further configured to identify trends in an estimated value of the pair of sneakers over a finite period of time. In one embodiment, the system further includes a local database configured to store price data obtained from the one or more online retail venues. In one embodiment, the server uses a neural network algorithm in the determination of the estimated value pair of sneakers.

Another embodiment of the present disclosure provides a method of ensuring sneakers, including: enabling a user to specify details regarding a pair of sneakers to be insured; displaying an estimated value of the pair of sneakers, wherein the estimated value of the pair of sneakers is determined by obtaining sales data from one or more online retail venues; presenting one or more insurance coverage plans for selection by the user, wherein a coverage value of the one or more insurance coverage plans is determined by the current estimated value of the pair of sneakers; and adjusting the coverage value of the one or more insurance coverage plans on a periodic basis, based on an updated estimated value of the pair of sneakers.

The details of one or more aspects of the disclosure are set forth in the accompanying drawings and the description below. Other features, objects, and advantages of the techniques described in this disclosure will be apparent from the description in the drawings, and from the claims.

### BRIEF DESCRIPTION OF THE DRAWINGS

The disclosure can be more completely understood in consideration of the following detailed description of various embodiments of the disclosure, in connection with the accompanying drawings, in which:

FIG. 1A is a computer architecture diagram depicting an automated insurance quote system and user interface configured to streamline an insurance process by calculating asset premiums based on a derived market value sourced from multiple resale sites and platforms, in accordance with an embodiment of the disclosure.

FIG. 1B is a block diagram depicting a portable computing device configured to enable user interaction with the automated insurance quote system, in accordance with an embodiment of the disclosure.

FIG. 2A is a screenshot depicting a login page of an automated insurance quote system, in accordance with an embodiment of the disclosure.

FIG. 2B is a screenshot depicting a sign-up page of an automated insurance quote system, in accordance with an embodiment of the disclosure.

FIG. 3A is a flowchart depicting a method of requesting and obtaining an insurance quote for a pair of sneakers, in accordance with an embodiment of the disclosure.

FIG. 3B is a screenshot depicting a sneaker selection page of an automated insurance quote system, in accordance with an embodiment of the disclosure.

FIG. 3C is a partial screenshot depicting a sneaker condition drop-down menu of an automated insurance quote system, in accordance with an embodiment of the disclosure.

FIG. 3D is a partial screenshot depicting an intended usage drop-down menu of an automated insurance quote system, in accordance with an embodiment of the disclosure.

FIG. 3E is a partial screenshot depicting a user selectable options of a sneaker menu of an automated insurance quote system, in accordance with an embodiment of the disclosure.

FIG. 3F is a screenshot depicting a first selectable insurance coverage plan of an automated insurance quote system, in accordance with an embodiment of the disclosure.

FIG. 3G is a screenshot depicting a second selectable insurance coverage plan of an automated insurance quote system, in accordance with an embodiment of the disclosure.

FIG. 3H is a screenshot depicting a third selectable insurance coverage plan of an automated insurance quote system, in accordance with an embodiment of the disclosure.

FIG. 3I is a screenshot depicting a comparison between multiple insurance coverage plans of an automated insurance quote system, in accordance with an embodiment of the disclosure.

FIG. 3J is a screenshot depicting a shopping cart filled with various insurance coverage plans of an automated insurance quote system including payable premiums, in accordance with an embodiment of the disclosure.

FIG. 3K is a screenshot depicting finalize insurance coverage quotation page of an automated insurance quote system, in accordance with an embodiment of the disclosure.

FIG. 3L is a screenshot depicting a payment page of an automated insurance quote system, in accordance with an embodiment of the disclosure.

FIG. 4 is a flowchart depicting a method of filing a claim on a previously insured pair of sneakers, in accordance with an embodiment of the disclosure.

FIG. 5A is a screenshot depicting a page of an automated insurance quote system, enabling a user to seek information regarding a current market value of a particular pair of sneakers, in accordance with an embodiment of the disclosure.

FIG. 5B is a screenshot depicting a page of an automated insurance quote system, enabling to view an estimated current market value of a particular pair of sneakers, in accordance with an embodiment of the disclosure.

FIG. 6A is a partial system architecture diagram of an automated insurance quote system for collecting data to estimate the value of a pair sneakers over a period of time for presentation in a graphical format, in accordance with an embodiment of the disclosure.

FIG. 6B is a schematic of a deep learning algorithm of an automated insurance quote system for processing sneaker valuation data, in accordance with an embodiment of the disclosure.

FIG. 6C is a schematic of a neuron of the deep learning algorithm of FIG. 6B, in accordance with an embodiment of the disclosure.

FIG. 7A is a screenshot depicting a dashboard page of an automated insurance quote system, enabling a user to view a representation of their sneaker collection, in accordance with an embodiment of the disclosure.

FIG. 7B is a screenshot depicting a current estimated value of their sneaker collection, in accordance with an embodiment of the disclosure.

FIG. 8A is a screenshot depicting certificates of authentication, appraisal and current insurance policies for shoes within a virtual collection of an automated insurance quote system, in accordance with an embodiment of the disclosure.

FIG. 8B is a screenshot depicting a certificate of authentication, in accordance with an embodiment of the disclosure.

FIG. 8C is a screenshot depicting a certificate of appraisal, in accordance with an embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

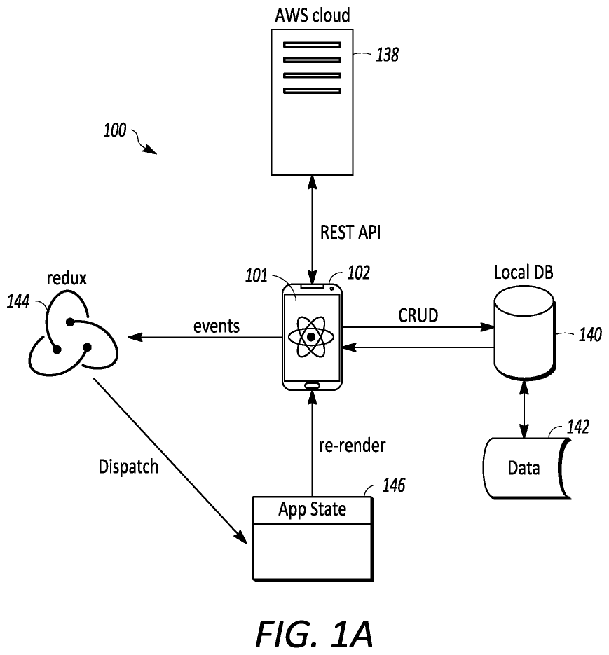

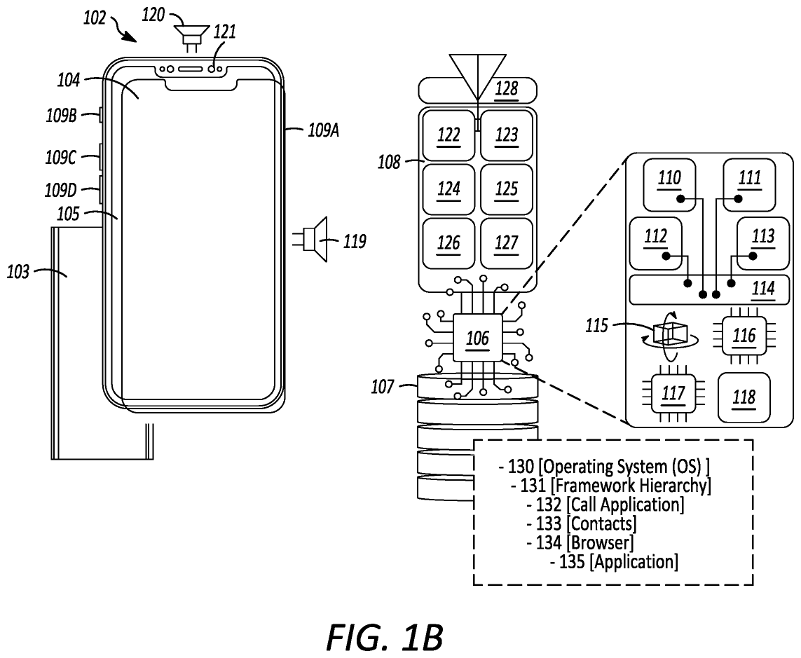

Referring to FIG. 1A, an automated insurance quote system 100 and user interface 101 configured to streamline an insurance process by calculating asset premiums based on a derived market value sourced from multiple resale sites and platforms, is depicted in accordance with an embodiment of the disclosure. In embodiments, the user interface 101 (and automated insurance quote system 100 generally) enhances the collection of information by gathering information directly from a user (e.g., a prospective or existing customer, agent, etc.) in real-time, near real-time, or after a delay at a physical or a virtual site. The system 100 can leverage data by offering quotes, insurance policies, and/or protection plans that are allowed or approved under the law and are tailored to user data or to a user's needs or preferences. The user interface 101 is configured to enable a user to select or enter details regarding footwear and their owners, and in some alternative systems, the effective dates of an insurance policy and/or a renewal term through an interface 101 such as an object-orientated interface (e.g., an interface in which elements are represented by screen entities). Accordingly, embodiments described by the present disclosure make it possible for sneaker consumers to accurately validate sneaker market value, receive instant appraisals via a quote, and specifically insure sneakers to protect their investment.

Some systems 100 comprise a local area and/or wide area network that split or divide processing of an application between a front-end client and a back-end server or server cluster that can be part of a client-server architecture. The client can comprise a local or remote computer or controller that can execute specific computer applications to send data over a network or pull content from an interactive website. A customized client-server protocol can be used to communicate between a privately accessible network and a publicly accessible network. The server or host server can comprise a single computer or a group of independent network servers that operate, and appear to local or remote clients, as if they were a single unit although they can be spread across a distributed network. The server can comprise hardware that can communicate with back-end processors that execute program(s) that provide time sharing and data management between local or remote clients, provides multi-user functionality, supports persistent and/or non-persistent connections with local or remote clients, and/or can provide or stand behind various firewalls and other security features. The logic and programming can be distributed among multiple memories that preserve data for retrieval and can provide access or support other devices, some of which can work independently but also can communicate with other remote or local devices that have similar or different operating systems 100.

The user interface 101 can format data so that it provides useful content that can be used or supplemented while reducing the amount of data entry required to process prospective or existing insurance policies through a self-servicing channel, an agent-servicing channel, and/or directly by insurance company representatives who can use the user interface 101 to make, receive, and/or adjust an application or an existing agreement for insurance on behalf of the consumer. In some embodiments, the automated insurance quote system 100 can include back-end processors that execute software that quantifies data. Insurance or other data can be quantified (e.g., in some cases, coverage priorities can be translated into numerical values or priority indicia that can be based on a numerical point scale) to evaluate policy preferences. A quote processor can perform specialized tasks such as selecting between competing coverage based on the translated priorities (e.g., such as those described by exemplary business rules). The quote processors can communicate with secondary processors (e.g., a processor can be considered a ‘secondary’ because the processor is subordinate to the quote processor and/or back-end processor, freeing the quote and back-end processors for other work) that perform the specialized task providing rapid access to a local and/or distributed database that retain quote details and/or recommendations. An offer of insurance to an applicant (and their acceptance) or an adjustment to an existing policy can occur automatically in real-time, near real-time, or after some delay. The automated insurance quote system 100 can enable a representative (or third party), such as insurance representatives, to validate applicant qualifications (e.g., error checking), facilitate insurance processing, and/or facilitate acceptance and/or changes. An application sharing controller or automated insurance quote system 100 can interface the server or client to provide a representative access to a shared document, an application, or views of a user's screen in real-time. The representative can facilitate an insurance quote or the execution of an insurance policy from a remote destination through a remote computer that has access to a publicly accessible distributed network.

The automated insurance quote system 100 can be coupled to multiple remote or local clients supporting web browsers and/or graphical user interfaces in some systems 100. Information can be encrypted, use digital signatures, or can be processed or supplemented with other security measures to protect the integrity of the information. Remote clients can be coupled to the system 100 through a matrix of networks, gateways, bridges, routers, and/or other intermediary devices that handle data transfer and/or data conversions from a sending network protocol to a similar or different receiving network protocol. Intraware, groupware, or other software executed by a processor can translate the data received from the clients, remote computers, or a remote automated online insurance quote system 100 into the data that is received and stored on a host server through a publicly accessible distributed network like the Internet or a privately accessible network like an Intranet. The data can include text, graphics, images, multimedia, and/or other information that can be stored at substantially the same rate as the data is received, after some delay, or at a near real time rate in memory resident to or coupled to the host server. The data can be received through communication with distributed or central commercial or governmental servers (e.g., state department of insurance or state commissioner of insurance servers). The commercial or governmental servers can serve specific or unique data about an applicant. Alternative data can define or describes the laws, rules, bulletins, rates, form filings, etc. that affects coverage or insurance policies (e.g., required rates, terms, coverage types, etc.). The data can be processed by a server, server cluster, processor, or client of the automated insurance quote system 100 to ensure that insurance applications, quotes, and/or policy offerings are in compliance with local, state, and/or other regulations (e.g., governmental laws or rules).

The specific approaches and methods as discussed herein can be used to insure any sneaker of value by assessing risk and probability of peril, damages or loss. In some embodiments, a user can begin by searching for a sneaker by inputting a shoe name, shoe size, and zip code. This information can be used to source that specific model (or similar models), calculate/derive market value from available sneaker resale platforms, further calculate a quote based on potential perils requiring (cleaning, restoration, or replacement), and produce a quote back to the user. This quote can then be used as the baseline value as the customer adds/removes coverage options. Based on customer/user coverage selections, the premium price can be adjusted to reflect those inputs. Once a desired coverage is selected, the customer can be presented a summary/payment screen to complete coverage.

With continued reference to FIG. 1A, the user interface 101 can be displayed on the screen of a mobile computing device 102, and can be in communication with a server cluster 138, which can serve as a data warehouse (e.g., include one or more databases that can be distributed and accessible to many computers and can retain information from one or many sources in a common or variety of formats), and in some alternative systems, can be linked to external content servers and legacy systems. For example, in some embodiments, the server cluster 138 can be an on-demand, cloud computing platform (e.g., Amazon Web services, Inc. (AWS) cloud, etc.) configured to provide basic abstract technical infrastructure and distributed computing building blocks and tools on a metered pay-as-you-go basis, available all the time, through the Internet. In such an embodiment, communications between the mobile computing device 102 and the server cluster 138 can conform to a representational state transfer application programming interface (REST API) architectural style.

Accordingly, the server clusters 138 can be configured to provide functionalities that enable users to obtain insurance through a self-service (or agent-service) communication channel. For example, the server clusters 138 can be configured to process or serve the tasks associated with applying, qualifying, and/or securing insurance, as well as to execute software that automates an insurance transaction and renders the dynamic, fixed, and/or variable content that can be delivered directly to an applicant or indirectly through an intermediary, such as an insurance agent, through a stateless controller or user interface 101. In some alternative systems, a user can seek insurance through a call center, an agent, (that can access the automated insurance quote system through an application sharing controller that interfaces the system) and/or a Web based application. The content can be accessed through a push (used to send data) and/or a pull technology (used to request data).

The details of a session or transaction can be stored in a local database 140 containing data records 142. For example, the mobile computing device 102 and local database 140 can cooperatively communicate to execute basic functions, such as creating, reading, updating and deleting (CRUD) the data records, during normal operations. In embodiments, the records can contain fields, together with a set of operations that facilitate searching, sorting, recombining, and other functions. In some embodiments, the local database 104 can comprise one or more databases (e.g., Structured Query Language databases or SQL DBs, databases that comprise one or more flat files, such as 2-dimensional arrays, etc.) that retain the information needed to qualify, validate, offer, recommend, revise, and/or execute insurance quotes.

While the local database 140 can be distributed across remote locations, accessed by several computers, and can contain information from multiple sources in a variety of formats, some databases 140 can be directly accessible to or resident to the server cluster 138 or a secondary processor. For longer term storage or data analysis, data can be retained in archival database(s). Some systems include a backup configured to enable the local database 140 to be restored to a transaction level when enabled. Accordingly, the system 100 can restore the local database 140 automatically when a software or hardware error has rendered some or the entire database 140 unusable. When a more serious error occurs, a backup database can automatically step in and assume the processes and functionality served by the local database 140 when the server cluster 138 or a monitoring system identifies software or hardware errors that have rendered a portion of the local database 140, or the entire database 140, unusable.

Events as a result of interaction with the user interface 101 can be communicated to an open-source JavaScript library 144 (e.g. redux) for managing and centralizing application state, which can in turn be dispatched to the application state 146 for re-rendering on the user interface 101. In some embodiments, the server cluster 138 can serve content through a Rich Internet Application (e.g., RIA). The RIA can run locally in a secure environment on a remote computer or client. A client engine or flash player can be activated when RIAs are received by the server cluster. The client engine can act as an extension of the browser, render the user interface, and can support synchronous and asynchronous communication (e.g., pre-fetching content) with the server cluster 138. In some RIA applications, insurance coverage characteristics can be downloaded to the client engine before content is requested by the user. These applications enable the system 100 to download one or many insurance coverages that can comprise one or more common or unique (e.g., customized to an applicant or client) insurance line items. In some systems, the client engine is run within a sandbox, comprising a closely-controlled remote environment that can have limited access to client resources. A Javascript can interface the client engine to provide some access to local and/or remote resources. In alternative applications, the client engine can rely on a certificate approach (e.g., ActiveX controls) that is not limited by sandbox restrictions. A certificate approach can be used by Java and Javascript programs and controllers.

In an alternative system, content can be delivered through markup language Web applications. The pages served by the server cluster 138 (and/or Web clusters in some alternative systems) can include links that allow users to select sneakers, customize line coverages, coverage limits, terms, and/or customize other characteristics associated with a prospective or an existing insurance policy. When a hyperlink associated with one or more particular insurance products or other choices is selected (e.g., a user can click on the link), the user can automatically receive content from the server clusters 138 (can occur through the Web clusters). Hyperlinks associated with the selection can include user or recipient information embedded by an input/output processor in a predetermined format that can be transmitted to a destination. In one implementation, the information can include unique identifiers which identify or encode the recipient's identity and an identifier of an insurance product or data associated with an insurance request. When content is transmitted through electronic messages, the hyperlink can identify or encode the identity of the recipient, and the selection of which can identify the identity of the recipient to the server clusters 138. In some alternative implementations, the selection of the hyperlink connects the user to content within the server cluster 138 and can validate the user.

With additional reference to FIG. 1B, a block diagram of a portable computing device 102 configured to enable user interaction with the automated insurance quote system 100 is depicted in accordance with an embodiment of the disclosure. In some embodiments, the portable computing device 102 can include a power source 103, a display 104, a sensor 105, a controller 106, storage 107, and a communication unit 108.

The display 104 can be a liquid crystal display (LCD), an organic light emitting diode (OLED) display, a plasma display panel (PDP), or the like. In some embodiments, a driving circuit, which can be implemented with an amorphous (a-Si) thin film transistor (TFT), a low temperature polysilicon (LTPS) TFT, an organic TFT (OTFT), or the like, can be included in the display 104. In some embodiments, the display 104 can include a backlight unit.

The sensor 105 can be configured to sense a user's touch on a surface of the display 104. The sensor 105 can be implemented with various types of sensing technology, such as a capacitive touch type sensor configured to sense micro-electricity excited to a user's body using a dielectric coating on a surface of the display 104 to calculate a touch coordinate, a resistive type sensor configured to include an upper and lower electrode plate built into the display 104 to sense current through the upper and lower electrode plates in contact with each other at a touch point to calculate touch coordinate, a piezoelectric type sensor, and the like. Thus, the sensor 105 can sense various types of user touch operations, including touch and hold, touch and drag, tap, double tap, flick, etc.

The controller 106 can control an overall operation of the portable computing device 102 using an operating system (OS) stored in the storage 107. The controller 106 can be configured to sense user input (e.g., via the sensor 106, hardware buttons 109A-D, voice commands, and other gestures) to perform functions corresponding to the user input. The storage 107 stores the OS for driving the device 102, programs, data, and other content. Specifically, the controller 106, in communication with the sensor 105, which can sense touch on a surface of the display 104, and compare a coordinate value of each object displayed on the display 104 with a touch coordinate value of the sensor 105 to determine which object is selected.

The controller 106 can include a random access memory (RAM) 110, a read-only memory (ROM) 111, a central processing unit (CPU) 112, a graphic processing unit (GPU) 113, a bus 114 and the like. The RAM 110, ROM 111, CPU 113 and GPU 113 can be communicatively coupled to one another through the bus 114. The CPU 112 can access the storage 107 to perform boot operations using the OS. A command set for system booting and the like may be stored in the ROM 111. When a turn-on command is input and power is supplied, the CPU 113 can copy the OS stored in the storage 107 to the RAM 110 according to a command stored in the ROM 118 and execute the OS to boot the system. When the booting is complete, the CPU 113 can copy various types of programs stored in the storage 107 to the RAM 110 and execute the programs copied to the RAM 110 to perform various types of operations. Alternatively, when an application is set as a default to run, the CPU 112 can automatically execute the application when the booting is complete. The GPU 113 generates graphical outputs for display on the screen 104. Specifically, the GPU 113 can perform rendering on the screen 104 based on the running program and sensed user input.

In some embodiments, the controller 106 can sense a rotation state, such that if the device 102 is rotated, a graphical output displayed on the screen 104 can be rotated to be considered generally upright relative to a gravitational frame of reference. For example, in some embodiments, the controller 106 can include a motion sensor 115 configured to sense a motion, such as a rotation state of the device 102 using a gyro sensor, geomagnetic sensor, an acceleration sensor, and the like. In addition to rotation, the controller 106 can perform various control operations according to a motion sensed by the motion sensor 115.

In addition to the CPU 112, the device 102 can include a number of other processors and units, including but not limited to an audio processor 116, a video processor 117 and a capturing unit 118. The audio processor 116 can be configured to perform processing on audio data, such as decoding, amplification, noise filtering, and the like. The video processor 117 can be configured to perform processing on video data, such as decoding, scaling, noise filtering, frame rate conversion, resolution conversion, and the like. The audio processor 116 and video processor 117 can be driven when a program for reproducing contents stored in the storage 107 or received from an external source are executed. The display 104 can display an image frame generated in the video processor 117, as well as various screens on which the GPU 113 performed rendering. A speaker 119 can output audio data generated by the audio processor 116. A microphone 120 can be configured to receive the user's voice or other sound for conversion into audio data. In some embodiments, the controller 106 can use the audio data received by the microphone 120 as sensed user input to perform certain functions. The capturing unit 118 can be configured to capture data via a camera 121.

The communication unit 108 enables communications between the device 102 and an external apparatus (e.g., a local area network, a Wi-Fi network, another portable computing device, etc.). The communication unit 108 can be configured to enable a variety of communication methods, including wireless local area network (LAN), wireless fidelity (Wi-Fi), Bluetooth, Zigbee, and the like. The communication unit 112 can include a wireless communication chip 122, Wi-Fi chip 123, a Bluetooth chip 124, and NFC chip 125, a GPS chip 126, a DMB receiver 127, and the like. The wireless communication chip 126 can denote a chip configured to perform communications according to various communication standards, such as Institute of Electrical and Electronic Engineers (IEEE), Zigbee, third generation (3G), fourth generation (4G), fifth-generation (5G), and long term evolution (LTE). The GPS chip 126 can be configured to receive a GPS signal from a GPS satellite and calculated current location of the device 102. The DMB receiver 127 is configured to receive and process a DMB signal. The communication unit 108 can include at least one among the above-described chips or chips according to other communication standards and perform communication with various external apparatuses using the chips. In some embodiments, the communication unit 108 can be in communication with an optional encoder/decoder 128 to at least one of aid in compression of wirelessly communicated information or impede the readability of the information intercepted by third parties.

The portable computing device 102 can further include one or more hardware buttons 109A-D. In some embodiments, the one or more hardware buttons 109A-D can include various types of buttons provided on a body of the device 102, such as a home button, pushbutton, touch button, wheel button, or the like.

In some embodiments, the device 102 may default to a locked state or condition to disable the display 104 when the user does not interact with the device 102 for a certain period of time. Pressing a hardware button 109A-D provided on the body of the device 102 can cause the display unit to display a lock screen. Preset gesture information to unlock the lock screen can be included in the data stored in the storage 107. When a user's touch is sensed by the sensor 105, the controller 106 determines whether or not the user touch operation matches the gesture information stored in the storage 107. Upon successful performance of an unlock operation on the lock screen, the display 104 can be unlocked, and either a home screen or one or more screens related to an application can be displayed. For example, if it is determined that the user touch operation matches the gesture information to open a specific application (e.g., an automated sneaker insurance quote and asset management application, etc.), the controller 106 enables the display 104, and executes the application corresponding to the user touch operation, to display one or more screens related to the application. In some embodiments, the controller 106 or hardware buttons 109A-D can be configured to unlock the device 102 and display one or more screens related to an application, even when the display 104 is locked or not fully enabled.

The controller 106 and other processors can comprise or include various modules or engines, each of which is constructed, programmed, configured, or otherwise adapted to autonomously carry out a function or set of functions. The term “engine” as used herein is defined as a real-world device, component, or arrangement of components implemented using hardware or as a combination of hardware and software, such as by a microprocessor system and a set of program instructions that adapt the engine to implement a particular functionality, which (while being executed) transform the microprocessor system into a special-purpose device.

An engine can also be implemented as a combination of hardware and software, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques.

Accordingly, each engine can be realized in a variety of physically realizable configurations, and should generally not be limited to any particular implementation exemplified herein, unless such limitations are expressly called out. In addition, an engine can itself be composed of more than one sub-engine, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

In some embodiments, the controller 106, storage 107 and other processors may include various types of software, such as an OS 130, a framework hierarchy 131, a call application 132, contacts 133, and a browser 134, as well as a variety of other programs and applications, such as an automated sneaker insurance quote application 135. The OS 130 can provide a set of commands to be executed by the controller 106 and other processors to manage basic functions of the device via various drivers and modules. For example, the OS 130 can drive a display driver configured to drive the display 104, a communication driver configured to enable the communication unit 108 to transmit/receive signals, a camera driver configured to drive the capturing unit 118, an audio driver configured to drive the audio processor 116, modules of a power manager, and the like to control the overall operation of the device 102.

The framework hierarchy 131 can establish an upper hierarchy within the OS 130. The framework hierarchy 131 performs functions for connecting respective application programs (e.g., the automated sneaker insurance quote application 135) of an application hierarchy to the OS hierarchy. For example, the framework hierarchy 131 can include a local manager, a notification manager, a frame buffer configured to display an image on the display 104, and the like. The application hierarchy can be configured to implement functions of the programs and applications loaded on the device 102 in the upper hierarchy of the framework hierarchy 131.

The automated insurance quote system 100 and associated methods as described herein can be implemented via a complex set of rules or logic (occasionally referred to herein as “functional modules”) defining the automated sneaker insurance quote application 135 on non-transitory computer recordable media. The functional modules can include, for example, Java applets (Java card applications that execute under the control of a Java Card Virtual Machine) and Java Classes (definitions for segments of code that may contain both data and functions that may operate on that data). The non-transitory computer-recordable medium is not a medium configured to temporarily store data such as a register, a cache, a memory, and the like but an apparatus-readable medium configured to semi-permanently store data. Specifically, the applications or programs as described herein may be stored and provided in the non-transitory computer-recordable medium such as a compact disc (CD), a digital versatile disc (DVD), a hard disc (HD), a blu-ray disc, a USB, a memory card, a read only memory (ROM), and the like. In some embodiments, the set of functional modules can be updated or altered without impacting the ability of the application functional modules to implement the desired functions and operations.

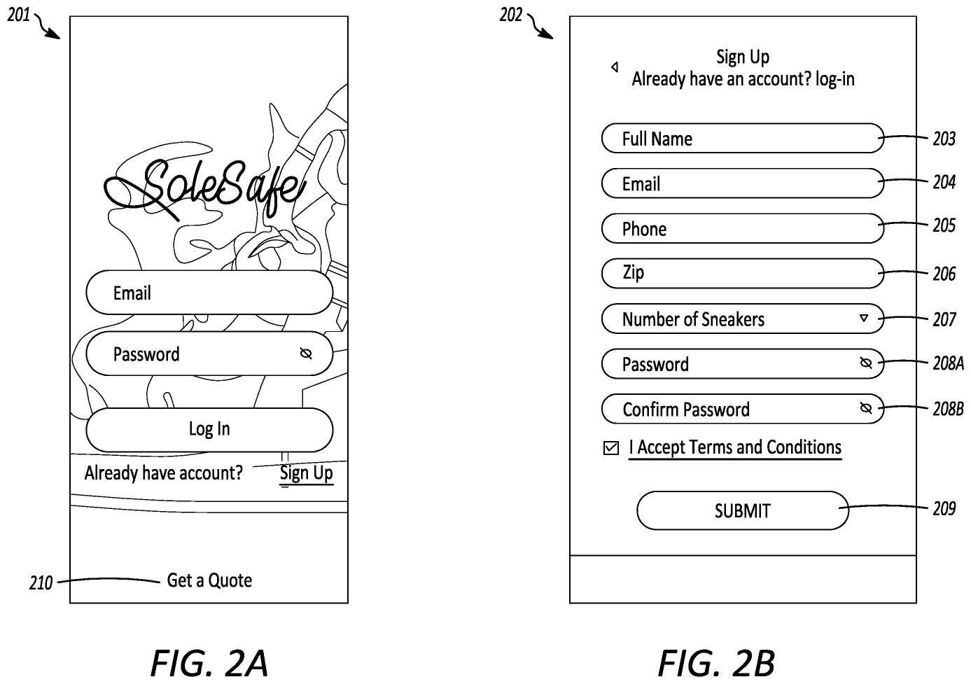

With reference to FIGS. 2A-B, to access the automated insurance quote system 100, in some embodiments, a user can either download the automated sneaker insurance quote application 135 to a mobile computing device 102 or access the automated sneaker insurance quote application 135 through a web browser to establish login credentials. For example, in some embodiments, a new user can be prompted with a sign-up page 202, which can prompt a user for user information, including but not limited to a full legal name 203, e-mail address 204, phone number 205, zip code 206, approximate number of sneakers in their current collection 207, as well as a desired password 208A-B. Upon entering the requested information, a user can submit 209 the data to establish an account and future login credentials. Thereafter, the user can use the login credentials (e.g., associated e-mail account 204 and password 208) to gain access to one or more features of the automated insurance quote system 100. In some embodiments, a user can obtain an insurance quote as a guest, for example by pressing the “Get a Quote” button or icon 210 on the login page 201, without a need to first establish an account or login credentials.

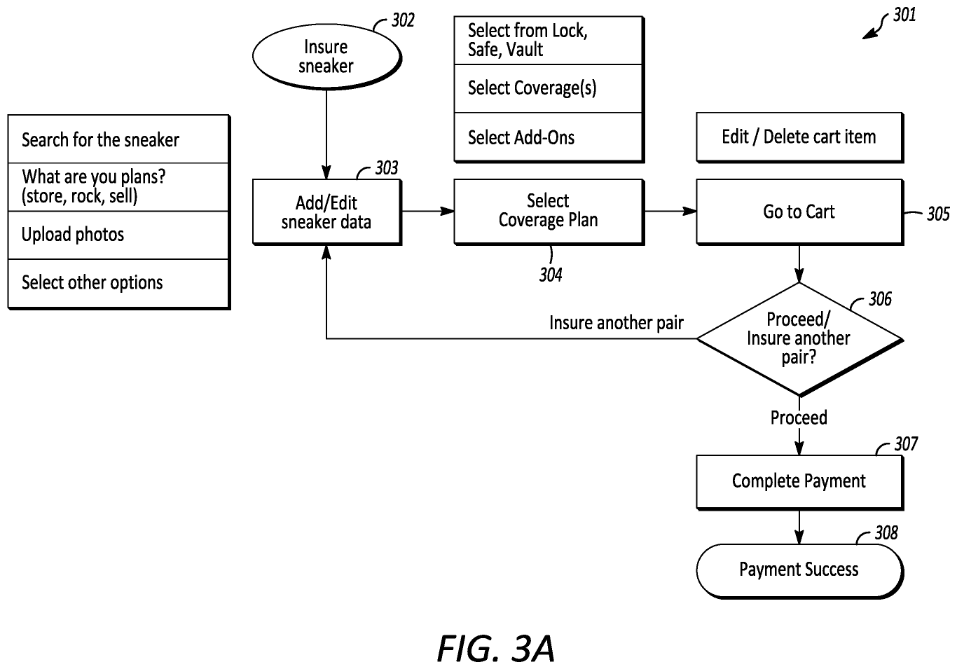

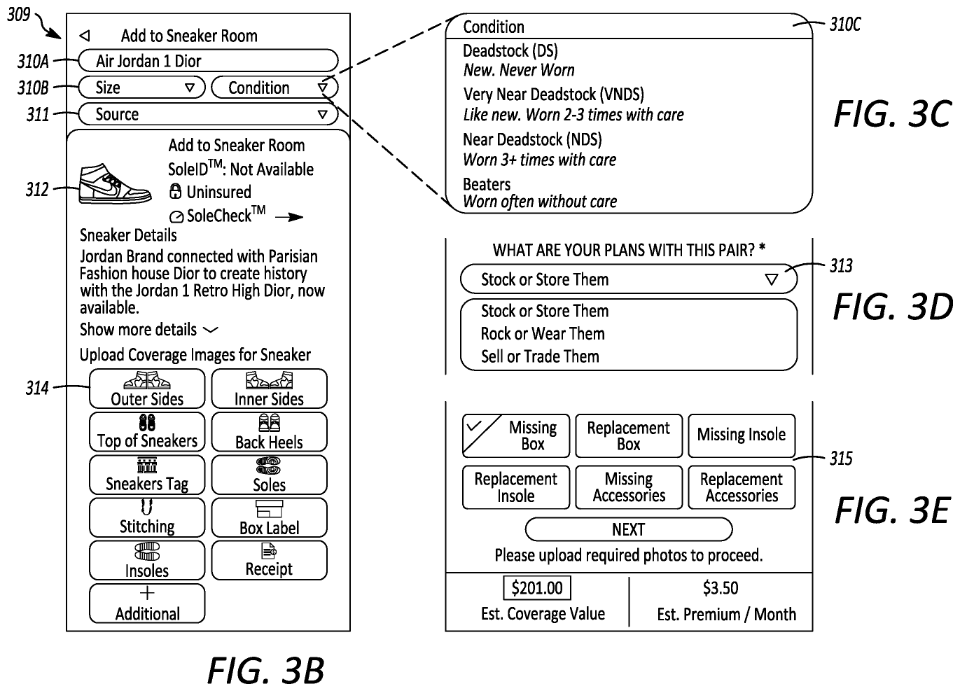

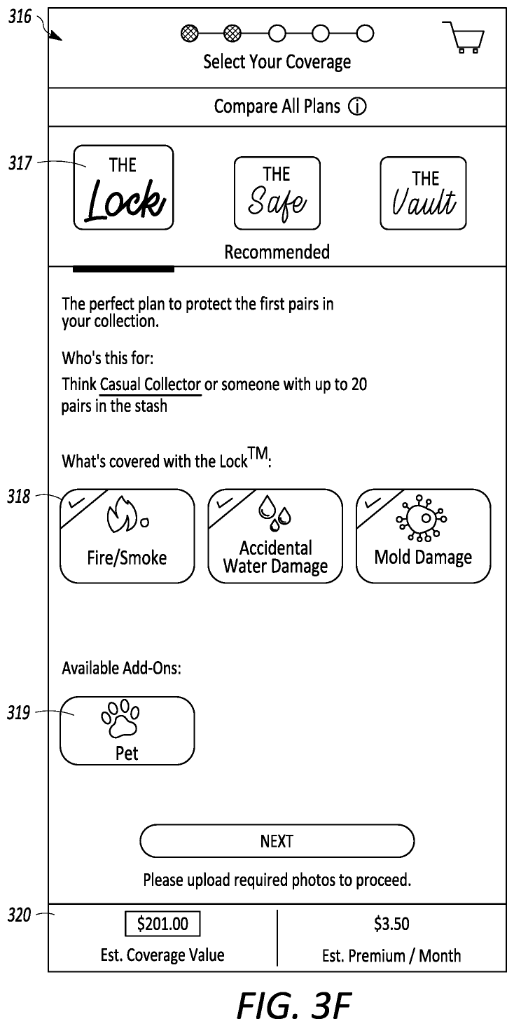

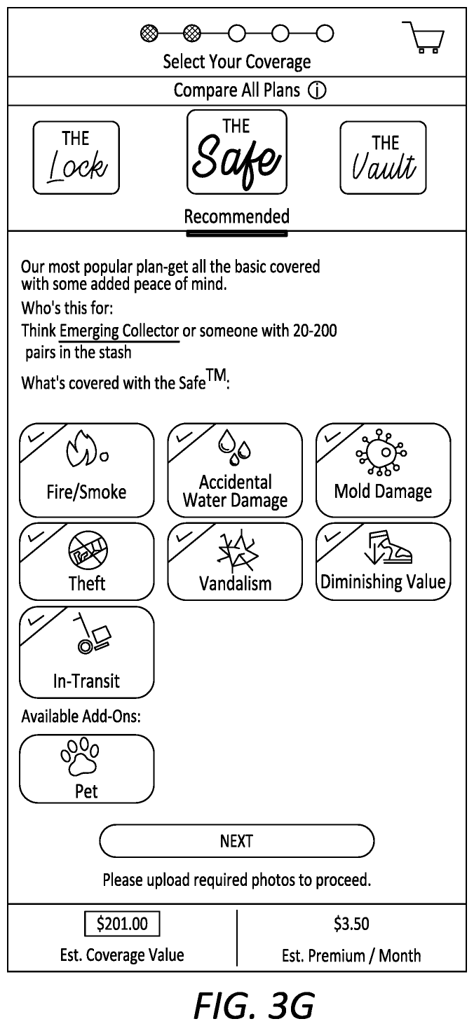

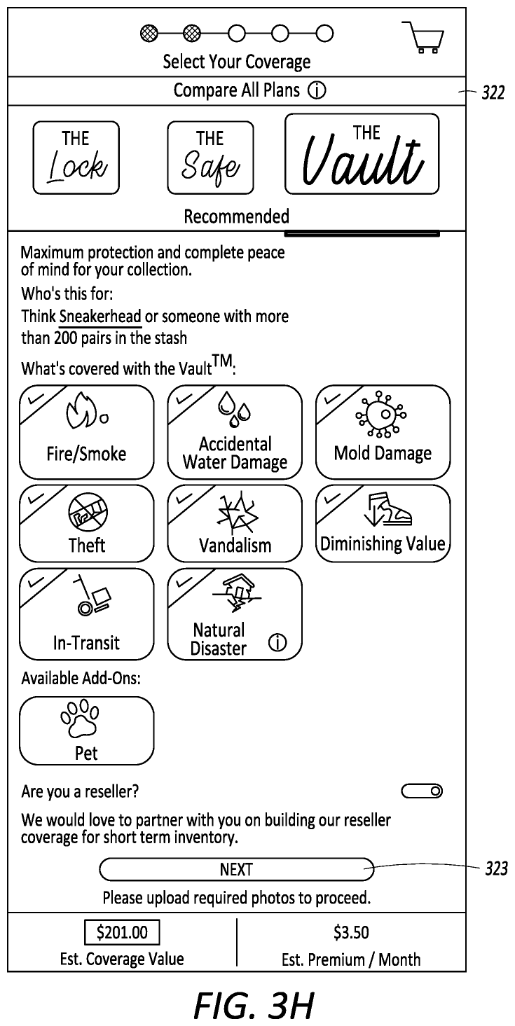

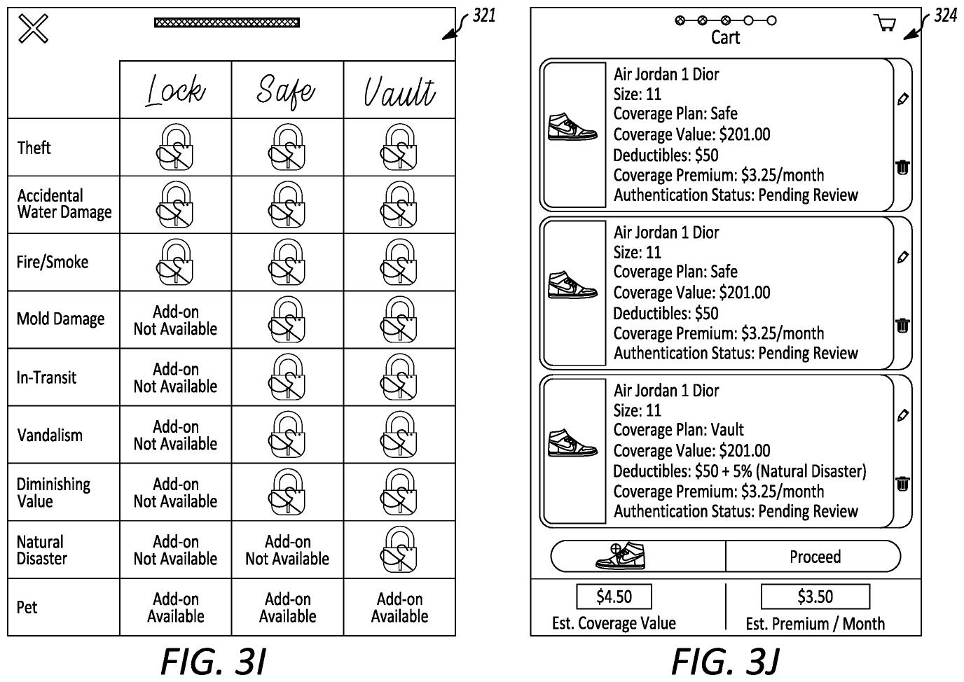

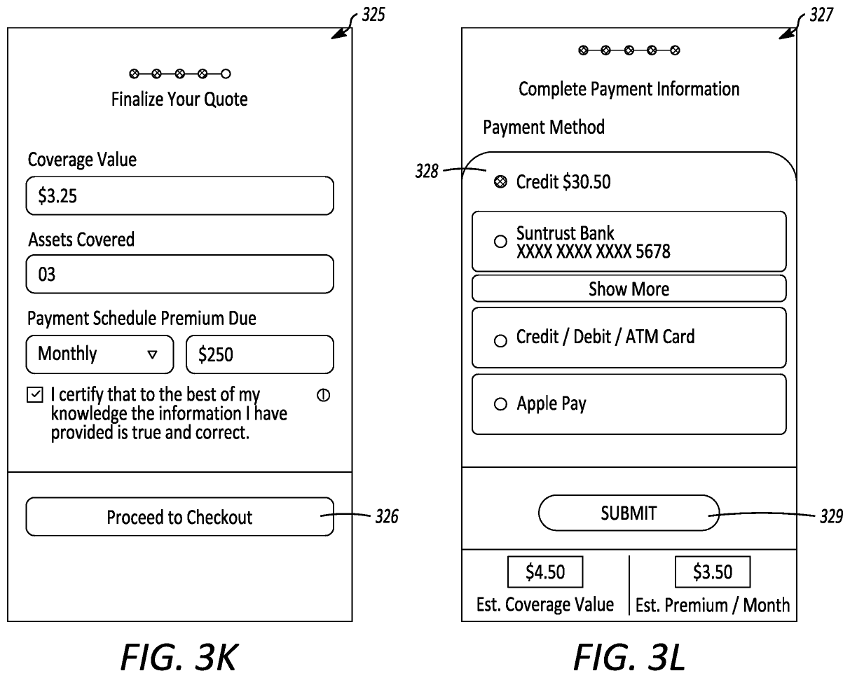

With reference to FIG. 3A, a flowchart generally depicting a method 301 of requesting and obtaining an insurance quote for a pair of sneakers is depicted in accordance with an embodiment of the disclosure. At 302, a user can request an insurance quote, for example by selecting the “Get a Quote” button or icon 210 on the login page 201, or through a menu of available options generally available within various screens provided by the user interface 101 of the automated insurance quote system 100. At 303, a user can add or edit data representing a pair of sneakers for insurance coverage.

With additional reference to FIG. 3B, in some embodiments, the user interface 101 can present a sneaker selection screen 309 including one or more fields 310A-C configured to enable a user to specify details regarding a sneaker. For example, as depicted, one field 310A can designate a general name for the sneaker (e.g., Air Jordan 1Dior, etc.), another field 310B can designate a size, which in some embodiments can include a drop down menu containing standard sneaker sizes applicable to the identified sneaker, while another field 310C can designate a selectable state or condition of the sneaker. For example, as depicted in FIG. 3C, various conditions of the sneaker can include: (i) deadstock, representing a new sneaker that has never been worn; (ii) very near deadstock, representing a sneaker that is like new (e.g., has been worn 2-3 times); (iii) near deadstock, representing a sneaker that has been worn more than three times, and (iv) beaters, representing a sneaker that has been regularly worn. Other fields may request selection of gender (e.g., selection of the gender/age group for which the sneaker was originally designed), brand (e.g., Nike, Adidas, Converse, Dior, New Balance, Puma, etc.), and other identifying information. In some embodiments, the sneaker selection screen 309 can enable a user to search for a particular shoe within a selectable database 311, which in some embodiments can be an online shoe retail website (e.g., a company store or secondary market).

In some embodiments, the sneaker selection screen 309 can include a sneaker identification section 312 configured to display a stock photograph of the sneaker, as well as some basic information and details configured to enable a user to confirm proper identification of a sneaker. With additional reference to FIG. 3D, as depicted by icons 313, the sneaker selection screen 309 can inquire what the user intends to do with the sneakers (e.g., store them, wear them, sell or trade them, etc.), as such details may affect both the term and premium of an insurance quote. With continued reference to FIG. 3B, as depicted in by icons 314, various images for the sneaker can be uploaded, including images of the outer soles, inner soles, top of the sneakers, back or heels of the sneakers, the tags, the soles, detailed the stitching, the box label (if applicable), the insoles (if applicable) the receipt, and any additional features that the user may wish to capture prior to obtaining insurance. With additional reference to FIG. 3E, as depicted in by icons 315, the user may options including whether the original box is missing, or has been replaced, whether the original insoles are missing or have been replaced, etc.

Referring again to FIG. 3A, at 304, the user can be presented with one or more insurance coverage plans for selection. For example, with additional reference to FIGS. 3F-I, the insurance coverage plans can include a number of different levels of insurance covering different casualties. For example, in one embodiment, the user interface 101 can present a select coverage screen 316 presenting the user with one or more selectable insurance coverage plans 317 (e.g., Lock, Safe, Vault, etc.) representing different levels of protection (as depicted in FIGS. 3F-H). The various types of casualties and available add-ons that each of the coverage plans 317 are designed to cover, can be presented in areas 318, 319 respectively. In some embodiments, an additional screen 321 (as depicted in FIG. 3I) providing a direct comparison between the selectable insurance coverage plans can be selectively presented by pressing the “Compare All Plans” button or icon 322 on the select coverage screen 316.

In embodiments, the various casualties covered by the levels of protection can include theft, accidental water damage, damage from smoke/fire, mold damage, damage caused during transfer to buyer/seller, vandalism, diminishing value, natural disaster (e.g., earthquake, tornado, flood in, wildfire, etc.), and damage from pets, etc. Other types of casualties are also contemplated. In some embodiments, the insurance coverage plans 317 can include available add-on casualties. For example, in some embodiments, a user may elect to ensure against damage caused by the user's pet, thereby enabling a user to customize their insurance needs.

Thereafter, an estimated coverage value of the sneaker (e.g., $201, etc.), which can be calculated according to various later described methods, along with an estimated monthly premium (e.g., $3.50, etc.) for the insurance policy can be depicted at area 320. Selection of the “Next” button or icon 323 enables a user to add the insurance policy to their shopping cart. The user may then continue shopping or proceed to their cart for payment. For example, referring again to FIG. 3A, at 305, a user can proceed directly to their cart, represented by screen 324 (as depicted in FIG. 3J). Alternatively, at 306, a user can elect to ensure another pair of sneakers, thereby directing the user back to step 303.

As depicted in FIG. 3K, a user can finalize an insurance quote represented by screen 325, and proceed to checkout, by selecting be “Proceed to Checkout” button or icon 326. At 307, a user can complete payment. For example, with additional reference to FIG. 3L, as represented by screen 327, a user can enter a desired payment method 328, followed by selection of a “Submit” button or icon 329. Thereafter, at 308, the user can be provided a confirmation of payment success.

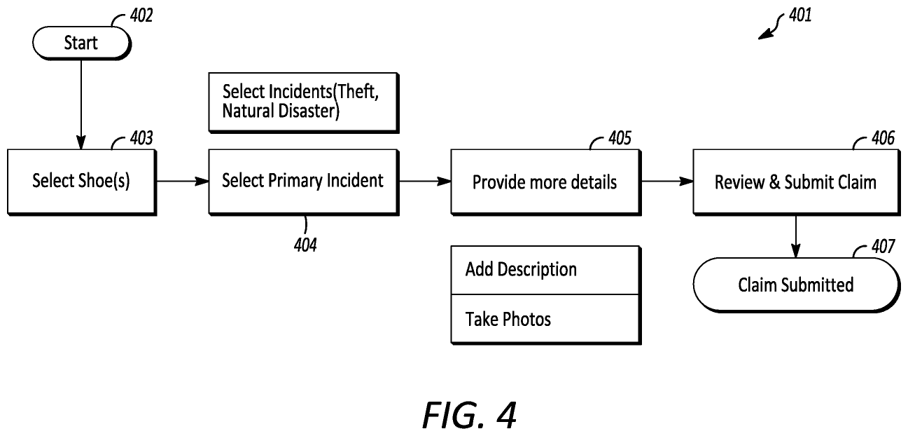

With reference to FIG. 4, a flowchart generally depicting a method 401 of filing a claim on a previously insured pair of sneakers is depicted in accordance with an embodiment of the disclosure. At 402, a user can follow a user menu to bring up one or more screens of the user interface 101 enabling the filing of an insurance claim. At 403, the user can select the pair of sneakers, which in some embodiments can be in the form of a drop-down menu including all of the sneakers presently insured by the user. At 404, the user can select the incident or type of casualty involved in the claim (e.g., the sneakers were stolen, damaged by mold, etc.). At 405, additional details regarding the incident or casualty can be provided, including a detailed description of the event or damage, as well as one or more pictures where applicable. At 406, the user can review and submit the claim. At 407, the user can receive confirmation that the claim has been submitted. Thereafter, a user can check on a status of the claim until the claim has been resolved.

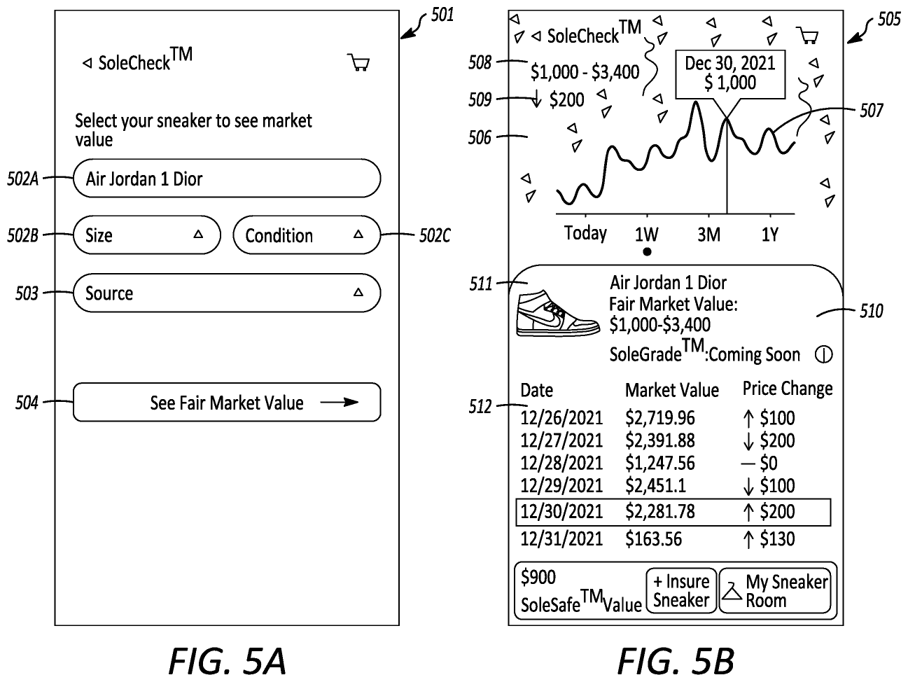

In addition to obtaining insurance coverage and filing claims for said coverage, the automated insurance quote system 100 is further configured to aid users in providing accurate valuation estimates for sneakers. For example, with reference to FIGS. 5A-B, in some embodiments, the user interface 101 can present a SoleCheck page 501 configured to enable a user to seek information regarding a current market value for a particular pair of sneakers, which in some embodiments can be dependent upon their condition and other factors. As depicted, in some embodiments, the SoleCheck page 501 can include one or more fields 502A-C (similar to fields 301A-C) into which sneaker identifying information can be entered. Thereafter, a user can restrict the valuation estimate to a particular source 503 (e.g., one or more secondary resale venue, etc.), or a user can select all available sources to establish a fair market value. Once data regarding the sneaker has been entered in the fields 502A-C and the source 503 has been selected, the user can select the “See Fair Market Value” button 504 to begin a query of the selected source or sources 503.

Thereafter, as depicted in FIG. 5B, an estimated value for pair of sneakers can be displayed in a graphical format, tabular format or a combination of both. For example, in one embodiment, an estimated value for the pair of sneakers over time can be presented in the form of a price graph 506. As depicted, the price graph 506 can optionally include a plot 507 of the estimated value for the pair of sneakers over a finite period of time, a minimum and maximum estimated value 508 during that finite period of time, and the most recent price change 509. In embodiments, a user can select the finite period of time to be displayed (e.g., 1-day, 1-week, 3-months, 1-year, etc.), with the ability to scroll a movable indicator along the price graph 506 for a display of the date an estimated value at any given point along the price graph 506.

As further depicted in FIG. 5B, the estimated value for the pair of sneakers over time can be presented in a tabular format 510, which can include general information 511 regarding the identified pair of sneakers, as well as a tabulated estimated market value 512, for example including the date, market value and price change. Other forms of presenting an estimated value for the pair of sneakers is also contemplated.

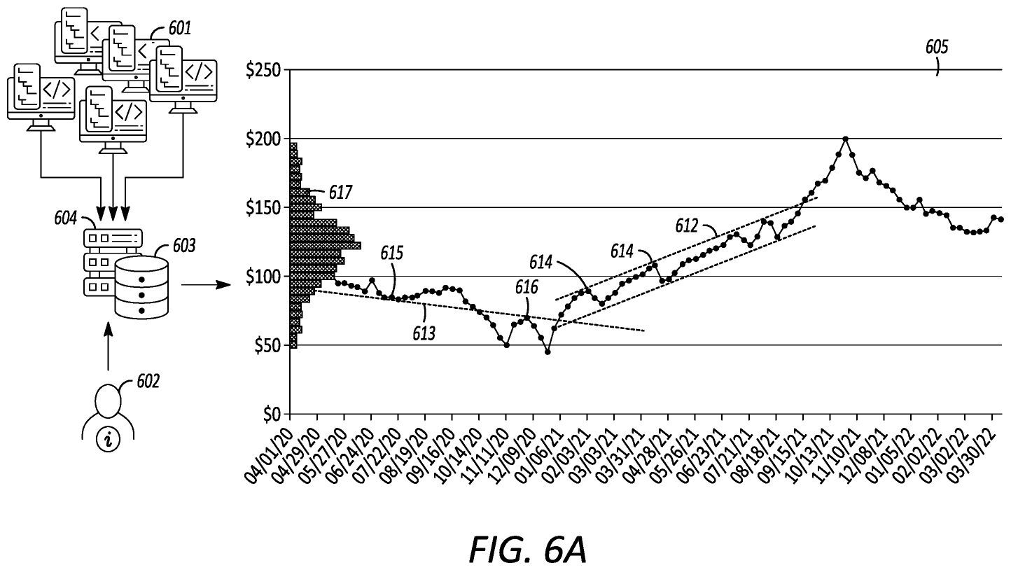

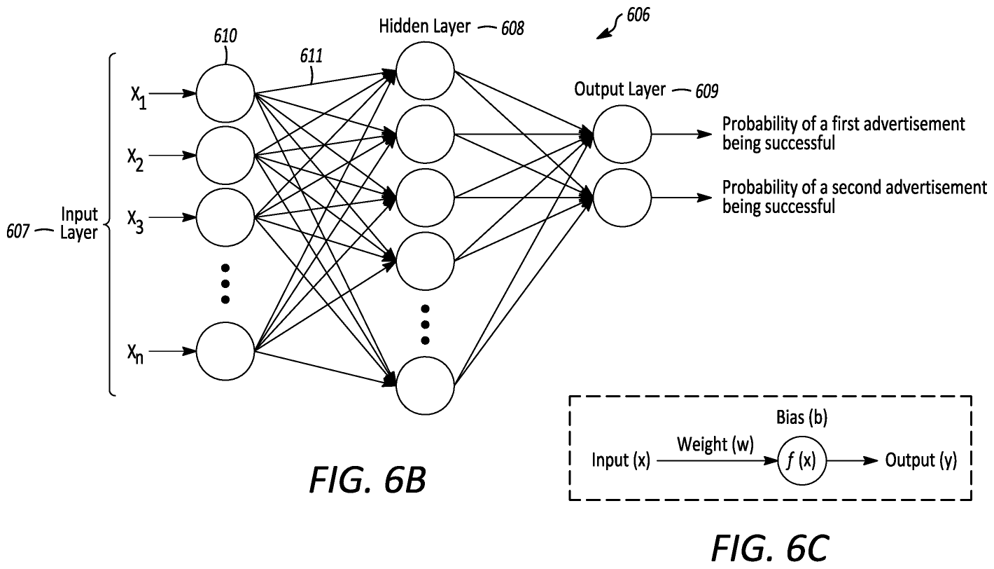

With additional reference to FIG. 6A, the source or sources of the estimated price data can include data obtained from one or more online retail venues 601 (e.g., “Flight Club,” “Stadium Goods,” “RIF,” “Sole Supremacy,” “Project Blitz,” “Index,” “StockX,” “GOAT,” “eBay,” “Urban Necessities,” “Sole Stage,” “KLEKT,” and the like), user entered information 602 (e.g., inventory, wish list, etc.), or other price, sales or inventory information can be gathered by one or more system databases 603. In embodiments, the sales data gathered by the databases 603 can include, for example, the sneaker type, brand and age, general condition, a list price, a sales price or best offer, date of sale, number of list days (e.g., length of auction, number of days listed at a fixed price, etc.), as well as how many other listings of the same or similar sneakers were published at the same time, and their respective list prices.

Thereafter, the price, sales and/or inventory information gathered by the system databases 603 can be analyzed by processor 604 to produce a price chart 605. In some embodiments, the processor 604 can employ an algorithm configured to use general data regarding sales of similar (but not identical) sneakers to create an estimated price chart 605 for a specific pair of sneakers. That is, the algorithm can use general sales data regarding comparable sneakers (e.g., different model sneakers), or sneakers of a different condition, size, color, etc. to create the estimated price chart 605 for a specific pair of sneakers.

In some embodiments, the processor 604 can employ a machine learning, deep learning algorithm, or other artificial intelligence to identify what potential price predictor or causal factor have the biggest influence on price (e.g., causal factors including, but not limited to, condition, size, color, rarity, type, brand, age, list price, sales price, sales venue, etc.). For example, in some embodiments, the algorithm can establish a numerical relationship or weighting for each of a number of identified price influential factors, thereby enabling increasing the reliability of general sneaker sales data in the prediction of an estimated price for a specific sneaker.

As depicted in FIG. 6B, in some embodiments, the deep learning algorithm can comprise a neural network 606, including an input layer 607, one or more hidden layers 608, and an output layer 609. Each of the layers 607, 608, and 609 can include a corresponding plurality of neurons 610. Although only a single hidden layer 608 is depicted, it is contemplated that the neural network 606 may include multiple hidden layers 608. The inputs for the input layer can be a number between 0 and 1. For example, in one embodiment, the input layer 607 can include one neuron for every potential price predictor or causal factor to be evaluated, with the value of each neuron of the input layer 607 being between 0 and 1; although other quantities of neurons and input values are also contemplated.

Each of the neurons 610 in a layer (e.g., input layer 607) can be connected to each of the neurons 610 of the subsequent layer (e.g., hidden layer 608) via a connection 611, as such, the layers of the network can be said to be fully connected. Although it is also contemplated that the algorithm 606 can be organized as a convolutional network, wherein one or more groups of neurons 610 within a layer can couple to corresponding one or more single neurons 610 and a subsequent layer, wherein each of the groups has a shared weighted value.

With additional reference to FIG. 6C, each of the neurons 610 can be configured to receive one or more input values (x) and compute an output value (y). In fully connected networks, each of the neurons 610 can be assigned a bias value (b), and each of the connections 611 can be assigned a weight value (w). Collectively the weights and biases can be tuned as the neural network 606 learns how to identify structure in the data. Each of the neurons 610 can be configured as a mathematical function, such that an output of each neuron 610 is a function of the connection weights of the collective input, and the bias of the neuron 610, according to the following relationship:

y=w·x+b

In some embodiments, output (y) of the neuron 610 can be configured to take on any value between 0 and 1. Further, in some embodiments the output of the neuron 610 can be computed according to one of a linear function, sigmoid function, tan h function, rectified linear unit, or other function configured to generally inhibit saturation (e.g., avoid extreme output values which tend to create instability in the network 606).

In some embodiments, the output layer 609 can include neurons 610 corresponding to a desired number of outputs of the neural network 606. For example, in one embodiment, the neural network 609 can include a single output neuron, with an output value of between 0 and 1 correlating to an adjusted price of a particular pair of sneakers. Other quantities of output neurons are also contemplated; for example, the output neurons could correspond to a weighting of each of the causal factors themselves.

The goal of the deep learning algorithm is to tune the weights and balances of the neural network 606 until the inputs to the input layer 610 are properly mapped to the desired outputs of the output layer 609, thereby enabling the algorithm 606 to accurately produce outputs (y) for previously unknown inputs (x). For example, with data gathered by the system fed into the input layer 607, one desired output of the neural network 606 would be to indicate an equivalent price of a particular sneaker from general sales data, with the goal of establishing price data for a sneaker that has no direct equivalent (e.g., size, condition, etc.) on the market. In some embodiments, the neural network 606 can rely on a sampling of training or control data (e.g., inputs with known outputs) to properly tune the weights and balances.

In tuning the neural network 606, a cost function (e.g., a quadratic cost function, cross entropy cross function, etc.) can be used to establish how close the actual output data of the output layer 609 corresponds to the known outputs of the training data. Each time the neural network 606 runs through a full training data set can be referred to as one epoch. Progressively, over the course of several epochs, the weights and balances of the neural network 606 can be tuned to iteratively minimize the cost function.

Effective tuning of the neural network 606 can be established by computing a gradient descent of the cost function, with the goal of locating a global minimum in the cost function. In some embodiments, a backpropagation algorithm can be used to compute the gradient descent of the cost function. In particular, the backpropagation algorithm computes the partial derivative of the cost function with respect to any weight (w) or bias (b) in the network 606. As a result, the backpropagation algorithm serves as a way of keeping track of small perturbations to the weights and biases as they propagate through the network, reach the output, and affect the cost. In some embodiments, changes to the weights and balances can be limited to a learning rate to prevent over fitting of the neural network 606 (e.g., making changes to the respective weights and biases so large that the cost function overshoots the global minimum). For example, in some embodiments, the learning rate can be set between about 0.03 and about 10. Additionally, in some embodiments, various methods of regularization, such as L1 and L2 regularization, can be employed as an aid in minimizing the cost function.

Referring again to FIG. 6A, in addition to generation of a price chart 605, in some embodiments, the algorithm can generate one or more price channels 612 and support/resistance lines 613 as an aid in determining changes in a price trend and/or general peaks and troughs along the price chart 605. In some embodiments, the algorithm can use two or more prices identified as being a local peak (e.g., the highest price within a relatively short period of time) or local trough (e.g., lowest price within a relatively short period of time) to establish a price channel 612. For example, the algorithm can be configured to draw a linear upper price channel between a first identified highest price within a 30-day rolling window and a second identified highest price within a 30-day rolling window. Similarly, the algorithm can be configured to draw a linear lower price channel between a first identified lowest price within a 30-day rolling window and a second identified lowest price within a 30-day rolling window. The upper and lower price channels 612 can then be extended along the x-axis, thereby providing a general indication of the future price along an established trend until the price crosses either of the upper or lower price channels, thereby indicating an end of the trend.

Support and resistance lines 613 can be established in a similar manner. As depicted at 615, an established support line 613 (e.g., a line drawn below the trending price) may be useful in determining a minimum sales price along a given trend, as the trending price may generally find support along the established support line 613. Conversely, as depicted at 616, where the price has fallen below the support line 613, the line may serve as resistance, as the trending price may generally have a tendency to stay below the line 613. A change in trend may be indicated when the price has generally been in an upward or downward trend, and the price breaks through the support/resistance line 613. In some embodiments, the algorithm can use a series of prices to establish a price by volume horizontal histogram 617 showing be volume of sneakers sold at a given price level, which can be indicative of support and resistance prices, as well as prices of particular importance to buyers and sellers.

The algorithm can additionally be useful in determining longer-term peaks and troughs along a price chart (e.g., a 52-week high/low, etc.), thereby indicating the potential bounds of the price of a particular sneaker, which can be useful in determining potential loss covered by the insurance policy (e.g., estimated coverage value), as well as the monthly premium for said insurance policy. In embodiments, longer-term peaks and troughs can also be indicative of an ideal time to either buy or sell a particular pair of sneakers.

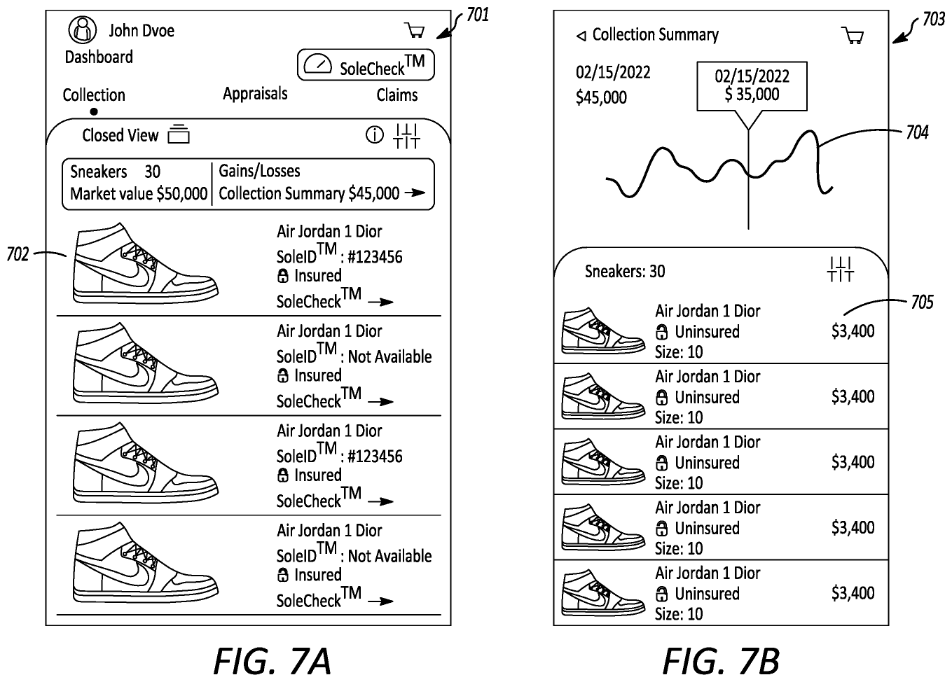

For example, with additional reference to FIG. 7A, a user can maintain a virtual sneaker collection represented by a dashboard page 701 presented by the user interface. The virtual sneaker collection 702 can serve as an autonomously updated inventory of a user's collection, with a new pair of sneakers added to the collection 702 upon obtaining an insurance policy. Thereafter, an estimated value of the sneaker can be continuously updated, with the next payable monthly premium adjusted to provide a coverage value the highest expected price during the month. Accordingly, embodiments of the present disclosure enable autonomous adjustment of monthly premiums to reflect estimated values, such that as the estimated value of a pair of sneakers increases, the estimated coverage value provided by the insurance increases in step, such that should a casualty occur, the user may receive a payout based on the current resale value of the sneaker (rather than the price of the sneakers when purchased and initially insured).

Conversely, if the estimated value of a pair of sneakers decrease, the monthly premium associated with the sneakers would also decrease to reflect the current market value. Thus, autonomous adjustment of monthly premiums enables users to maintain appropriate insurance coverage levels, while ensuring that the user is not overpaying in monthly premiums for insurance policies that exceed current market values.

As depicted in FIG. 7B, a collection summary page 703 can provide an overview of a user's collection, including a price graph 704 as well as a tabular sneaker inventory 705. In addition to autonomous adjustment of monthly premiums, determining a current estimated value for each pair of sneakers can also be useful in determining ideal times to buy and sell sneakers. For example, a user may indicate a desire to sell a particular pair of sneakers within the inventory. As previously discussed in connection with FIGS. 6A-B, the one or more system algorithms can determine ideal times to sell sneakers based on both price action and the number of auctions, offerings or other advertisements generally listing a particular pair of shoes for sale. Where it is determined that the current sales environment may support a generally high sales price, the user may receive a notification, which may include a recommended price and venue.

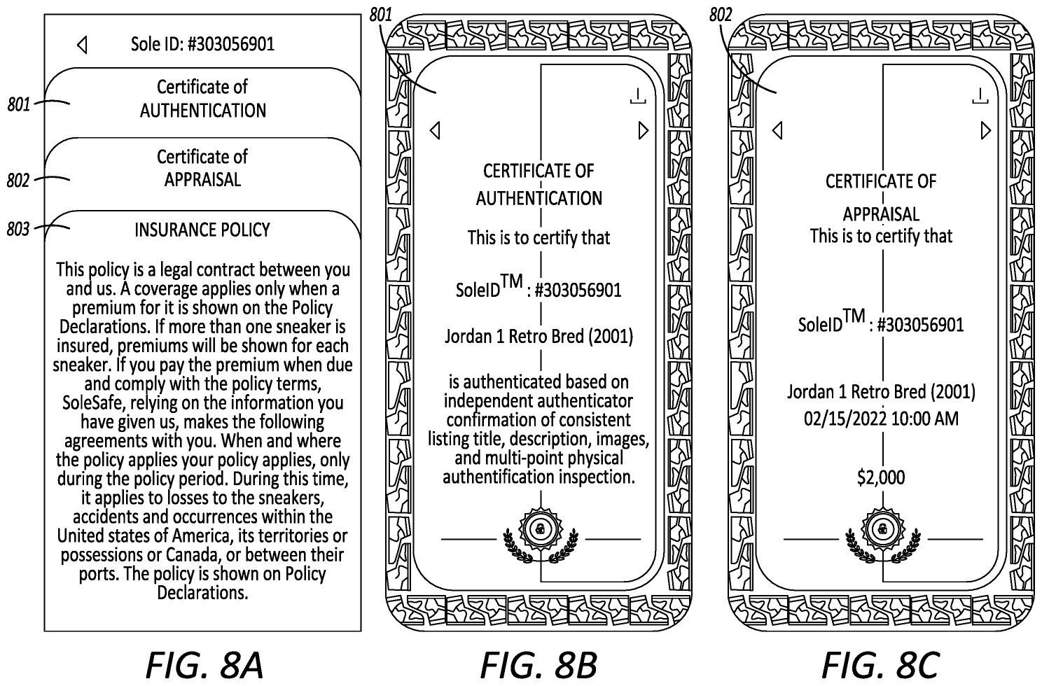

With additional reference to FIGS. 8A-C, in some embodiments, the system can be configured to generate a digital certificate of authenticity 801, digital certificates of appraisal 802, and proof of insurance 803, which may tend to establish a higher level of trust in the seller and the quality and authenticity of the sneakers, thereby potentially boosting the sales price of the sneakers. In some embodiments, the price listed on the digital certificate of appraisal 802 can be generated by the algorithm according to any of the methods discussed above.

In addition to determining an ideal time to sell a particular pair of sneakers in the user's inventory, in some embodiments, the system can also be useful in determining an ideal time to buy. For example, a user may add one or more pair of sneakers to their wish list. Thereafter, the system can periodically monitor prices for the identified sneakers, with the user receiving a notification when market conditions generally indicate a good time to purchase sneakers on the wish list.

It should be understood that the individual steps used in the methods of the present teachings can be performed in any order and/or simultaneously, as long as the teaching remains operable. Furthermore, it should be understood that the apparatus and methods of the present teachings can include any number, or all, of the described embodiments, as long as the teaching remains operable.

Various embodiments of systems, devices, and methods have been described herein. These embodiments are given only by way of example and are not intended to limit the scope of the claimed inventions. It should be appreciated, moreover, that the various features of the embodiments that have been described can be combined in various ways to produce numerous additional embodiments. Moreover, while various materials, dimensions, shapes, configurations and locations, etc. have been described for use with disclosed embodiments, others besides those disclosed can be utilized without exceeding the scope of the claimed inventions.

Persons of ordinary skill in the relevant arts will recognize that the subject matter hereof can comprise fewer features than illustrated in any individual embodiment described above. The embodiments described herein are not meant to be an exhaustive presentation of the ways in which the various features of the subject matter hereof can be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim can refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. An automated insurance quote system, comprising:
a user interface presentable on a display of one or more mobile computing devices in electrical communication with one or more servers, the user interface configured to
enable a user to specify details regarding a pair of sneakers to be insured;
display an estimated value of the pair of sneakers, wherein the estimated value of the pair of sneakers is determined by obtaining sales data from one or more online retail venues; and
present one or more insurance coverage plans for selection by the user, wherein a coverage value of the one or more insurance coverage plans is determined by the current estimated value of the pair of sneakers.

2. The automated insurance quote system of claim 1, wherein specifying details regarding the sneakers includes at least one of identifying a brand, model, gender, size, color or condition of the pair of sneakers.

3. The automated insurance quote system of claim 1, wherein the user interface is further configured to display at least one of a stock photograph or general information regarding the pair sneakers to enable a user to confirm proper identification of the pair of sneakers.

4. The automated insurance quote system of claim 1, wherein the user interface is further configured to enable the user to specify an intended usage of the pair of sneakers.

5. The automated insurance quote system of claim 1, wherein the user interface is further configured to enable user to select one or more online retail venues for use in determining the estimated value of the pair sneakers.

6. The automated insurance quote system of claim 1, further comprising a local database configured to store price data obtained from the one or more online retail venues.

7. The automated insurance quote system of claim 1, wherein the system is configured to autonomously adjust the coverage value of the one or more insurance coverage plans on a periodic basis, based on an updated estimated value of the pair of sneakers.

8. The automated insurance quote system of claim 1, wherein the user interface is further configured to display an estimated value of the pair of sneakers over a finite period of time.

9. The automated insurance quote system of claim 1, wherein the system is configured to identify trends in an estimated value of the pair of sneakers over a finite period of time.

10. The automated insurance quote system of claim 1, wherein the system is configured factor the number of similar pairs of sneakers currently for sale on the one or more online retail venues in a determination of a current estimated value of the pair of sneakers.

11. The automated insurance quote system of claim 1, wherein the system is configured to employ a neural network algorithm in the determination of the estimated value pair of sneakers.

12. The automated insurance quote system of claim 1, wherein the user interface is further configured to present a virtual collection of pairs of sneakers and the estimated current value associated with each pair of sneakers in the virtual collection.

13. The automated insurance quote system of claim 1, wherein the user interface is further configured to present a certificate of appraisal for the pair of sneakers.

14. An automated insurance quote system, comprising:
a server configured to communicate with one or more mobile computing devices, the server configured to receive details regarding a pair of sneakers to be insured, obtain sales data for the pair of sneakers from one or more online retail venues to determine a value of the pair of sneakers, and enable the selection of one or more insurance coverage plans for the pair of sneakers, wherein a coverage value of the one or more insurance coverage plans is determined by the current estimated value of the pair of sneakers.

15. The automated insurance quote system of claim 14, wherein the server is further configured to autonomously adjust the coverage value of the one or more insurance coverage plans on a periodic basis, based on an updated estimated value of the pair of sneakers.

16. The automated insurance quote system of claim 14, wherein the server is further configured factor the number of similar pairs of sneakers currently for sale on the one or more online retail venues in a determination of a current estimated value of the pair of sneakers.

17. The automated insurance quote system of claim 14, wherein the server is further configured to identify trends in an estimated value of the pair of sneakers over a finite period of time.

18. The automated insurance quote system of claim 14, further comprising a local database configured to store price data obtained from the one or more online retail venues.

19. The automated insurance quote system of claim 14, wherein the server uses a neural network algorithm in the determination of the estimated value pair of sneakers.

20. A method of ensuring sneakers, comprising:
enabling a user to specify details regarding a pair of sneakers to be insured;
displaying an estimated value of the pair of sneakers, wherein the estimated value of the pair of sneakers is determined by obtaining sales data from one or more online retail venues;
presenting one or more insurance coverage plans for selection by the user, wherein a coverage value of the one or more insurance coverage plans is determined by the current estimated value of the pair of sneakers; and
adjusting the coverage value of the one or more insurance coverage plans on a periodic basis, based on an updated estimated value of the pair of sneakers.
